(19) United States
(12) Patent Application Publication
(10) Pub. No.: US 2009/0051637 A1
(43) Pub. Date: Feb. 26, 2009

(54) DISPLAY DEVICES

(75) Inventors: Shing-Chia Chen, Tainan County (TW); Ling-Shiou Huang, Tainan County (TW); Lin-Kai Bu, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HIMAX TECHNOLOGIES LIMITED, Tainan County (TW)

(21) Appl. No.: 11/841,052

(22) Filed: Aug. 20, 2007

(51) Int. Cl. G09G 5/02; G09G 5/10

(52) U.S. Cl. 345/88; 345/84; 345/690

(57) ABSTRACT

A display device comprises a processor for receiving an image signal and generating a data signal and a luminance signal accordingly, a display panel comprising display cells, a data driver generating driving signals according to the data signal for driving the display cells, and a backlight module comprising light emitting elements, each light emitting element being arranged to correspond to each display cell respectively for emitting light to each display cell according to the luminance signal.

### BACKGROUND OF THE INVENTION

1. Field of the Invention

The invention relates to a display device, and more particularly to a display device with dynamic backlight source.

2. Description of the Related Art

A liquid crystal panel is comprised of two glass substrates and a liquid crystal layer inserted therebetween. The liquid crystal panel is, for example, utilized in the LCD, the LCD TV, and the display devices of the portable electronic equipments, such as lap-top computer, mobile phones, PDA and etc.

The transmissive liquid crystal panel uses a backlight as a light source. Since the backlight is typically a white light source, for a color LCD, each pixel is generally comprised of three sub-pixels corresponding with a red filter, a green filter, and a blue filter, respectively. The desired color displayed by each pixel is obtained by controlling the amount of light passing through each sub-pixel according to each color filter. FIG. 1 schematically illustrates a conventional display device 10 with an LCD panel 100 and a backlight including CCFLs (cold cathode fluorescent lamps) 110. By controlling the voltage applied across the liquid crystal layer in each pixel, the liquid crystal molecules are deflected and the light generated by the CCFLs can be allowed to pass through in varying amounts. Thus each pixel is illuminated.

As shown in FIG. 1, in an LCD panel, a wide area of pixels lying above one CCFL are illuminated at the same by this CCFL. However, there exists a TFT switching element limitation because the thin film transistor (TFT) used in an LCD panel cannot completely turn on or off. Such a TFT switching element limitation causes the LCD panel to not be able to precisely control the desired brightness for each pixel while using the CCFLs as the backlight module.

### BRIEF SUMMARY OF THE INVENTION

Display devices are provided. An exemplary embodiment of such a display device comprises a processor for receiving an image signal and generating a data signal and a luminance signal accordingly, a display panel comprising display cells, a data driver generating driving signals according to the data signal for driving the display cells, and a backlight module comprising light emitting elements, each light emitting element being arranged to correspond to each display cell respectively for emitting light to each display cell according to the luminance signal.

Another exemplary embodiment of A display device comprises a processor for receiving an image signal and generating a data signal and a luminance signal accordingly, a display panel comprising display cells, wherein each pixel unit comprises a red display cell, a green display cell and a blue display cell, a data driver generating driving signals according to the data signal for driving the display cells, and a backlight module comprising light emitting elements, each light emitting element being arranged to correspond to each display cell respectively for emitting light to each display cell according to the luminance signal.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 schematically illustrates a conventional display device with an LCD panel and CCFLs provided as a backlight module;

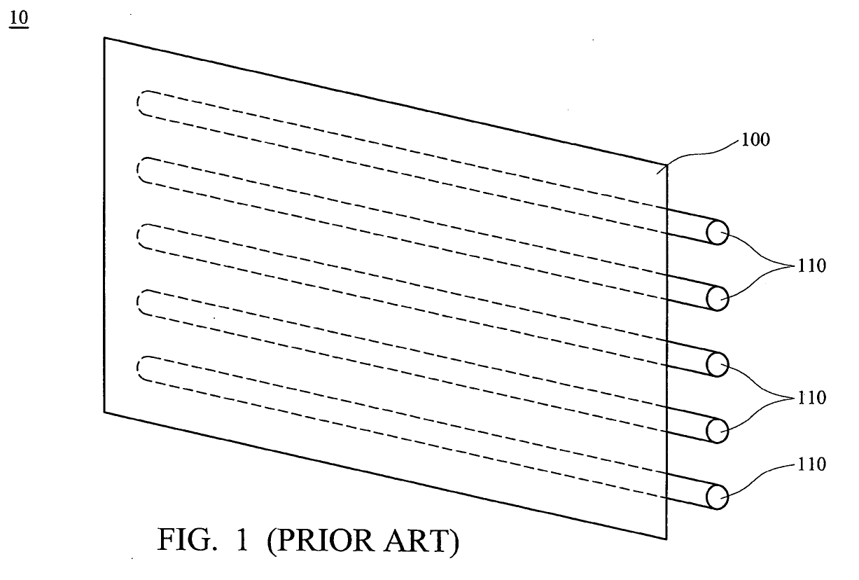

FIG. 2 schematically illustrates a display device according to an embodiment of the invention;

FIG. 3 schematically illustrates the circuit driver of a display device according to an embodiment of the invention;

FIG. 4 schematically illustrates a display device according to another embodiment of the invention;

FIG. 5 schematically illustrates the arrangement between of one pixel unit and one light emitting element shown in FIG. 4; and

FIG. 6 schematically illustrates the circuit driver of a display device according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

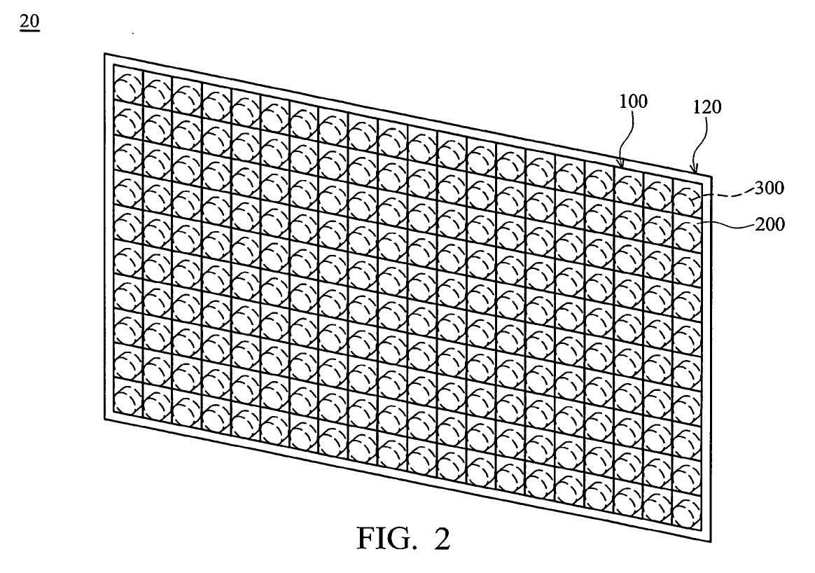

FIG. 2 schematically illustrates a display device 20 according to an embodiment of the invention. Display device 20 comprises an LCD panel 100 and a backlight module 120, wherein LCD panel 100 comprises a plurality of display cells 200. According to the embodiment of the invention, backlight module 120 can be an OLED panel with a plurality of light emitting elements 300, each light emitting element 300 may corresponding one or more liquid crystal display cells 200. In this illustrated embodiment, each light emitting element 300 corresponds to one liquid crystal cell 200.

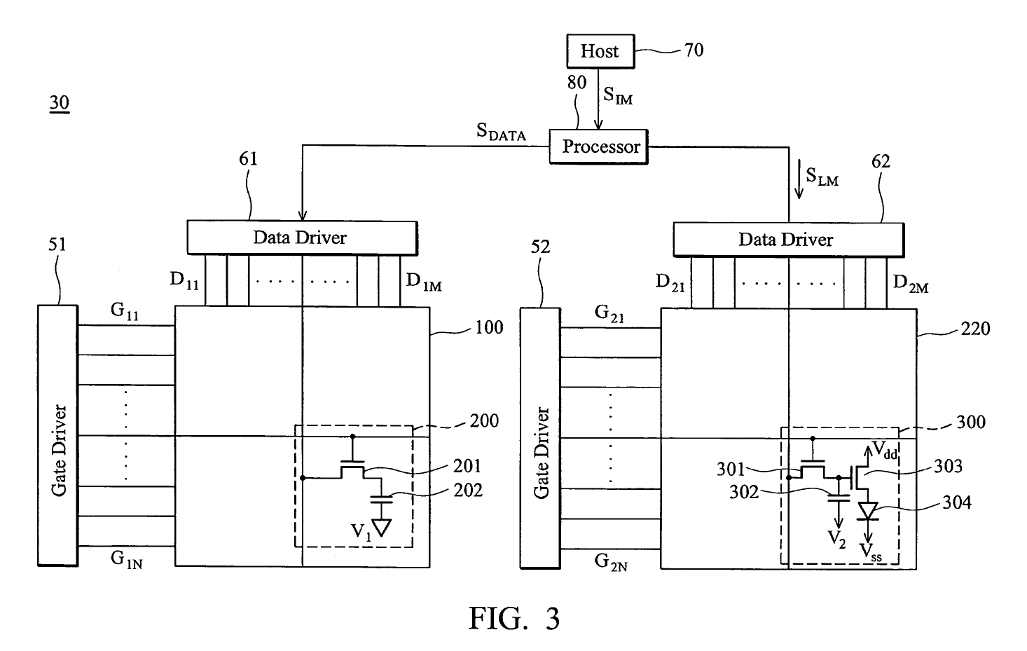

FIG. 3 schematically illustrates the circuit driver of a display device 30 according to an embodiment of the invention. Display device 30 comprises a processor 80, an LCD panel 100, an OLED panel 220, a data driver 61, a gate driver 51, a data driver 62 and a gate driver 52. The processor 80 may adjust the attributes of the image signal S_{IM} from a host 70, such as the contrast, brightness and etc., to generate the data signal S_{DATA}. The processor 80 further generates a luminance signal S_{LM} to the data driver 62 according to the image signal S_{IM}. The data driver 51 receives the data signal S_{DATA} to generate driving signals for driving the LCD panel 100. The data driver 62 receives the luminance signal S_{LM} to generate driving signals for driving the OLED panel 220.

In LCD panel 100, a plurality of display cells 200 are arranged to form a matrix. Display cells 200 are connected to a plurality of data lines D₁₁, D₁₂, . . . , D_{1M} and a plurality of gate lines G₁₁, G₁₂, . . . , G_{1N}. The equivalent circuit of each display cell 200 includes a switch 201, which may be a TFT, and a capacitor 202 connected between the switch 201 and a supplied voltage V₁. The gate driver 51 outputs scan signals to each gate lines G₁₁, G₁₂, . . . , G_{1N} according to a predetermined sequence. When one gate line is asserted by a scan signal, the switches 201 within display cells on the same row are turned on. Then, the data driver 61 outputs the driving signals (gray values) to the corresponding display cells 200.

In OLED panel 220, the light emitting elements 300 are arranged to form a matrix. Light emitting elements 300 are connected to data lines D₂₁ D₂₂, . . . , D_{2M} and gate lines G₂₁, G₂₂, . . . , G_{2N}. Each emitting element 300 includes a data switch 301, which may be a TFT, a capacitor 302, a driving switch 303 and an OLED 304. The driving switch 303 is a TFT that generates a driving current for driving the OLED 304 for producing light. The gate driver 52 outputs one or more scan signals to each gate lines G₂₁, G₂₂, . . . , G_{2N} according to a predetermined sequence. When one gate line is asserted by a scan signal, the corresponding data switches 301 within the light emitting elements 300 on the same row are turned on. Then the data driver 62 controls the corresponding light emitting elements 300 through data lines D₂₁, D₂₂, . . . , D_{2M} to emit light according to luminance signal S_{LM}. There are also other types of pixel circuits for driving the OLEDs 304 known by the person skilled in the art.

According to one embodiment of the invention, each display cell 200 shown in FIG. 3 may correspond to a single pixel on a monochromatic LCD, or a single sub-pixel on a color LCD, wherein the sub-pixel can be a red sub-pixel, a blue sub-pixel, or a green sub-pixel, respectively. That is, for a color LCD, each three display cells 200 form a pixel unit, wherein the three display cells 200 in a pixel unit will be a red display cell, a green display cell, and a blue display cell, respectively. According to the embodiments of the invention, the light emitting element 300 may emit white light when the LCD panel is a monochrome LCD or a color LCD with color filers, or the light emitting element may emit red, blue or green light if the LCD panel is a color LCD without color filter. Thus, the light emitting element 300 may be a white light emitting element, a red light emitting element, a green light emitting element, or a blue light emitting element, accordingly.

According to one embodiment of the invention, the processor 80 generates the data signal S_{DATA} by adjusting an attribute of the image signal S_{IM}, such as the contrast ratio, brightness thereof, and generates the luminance signal S_{LM} based on the adjusted image attribute. According to another embodiment of the invention, since the image signal S_{IM} for a color LCD comprises brightness of a red channel signal, a green channel signal and a blue channel signal of each pixel unit, processor 80 generates luminance signal S_{LM} to the data drive 62 according to those individual brightness information of each pixel. In the embodiment of the invention, since each light emitting element 300 is arranged corresponding to each display cell 200, each light emitting element 300 can act as an individual backlight source for each display cell 200. For example, when there is a black pixel adjacent to a white pixel for an image data is to be displayed, the corresponding light emitting elements of the black pixel do not illuminate while the corresponding light emitting elements of the white pixel do generate a white light. In this way, the display device 30 can not only dynamically and precisely control the brightness of each individual display cell, but also achieve better contrast and reduce power consumption.

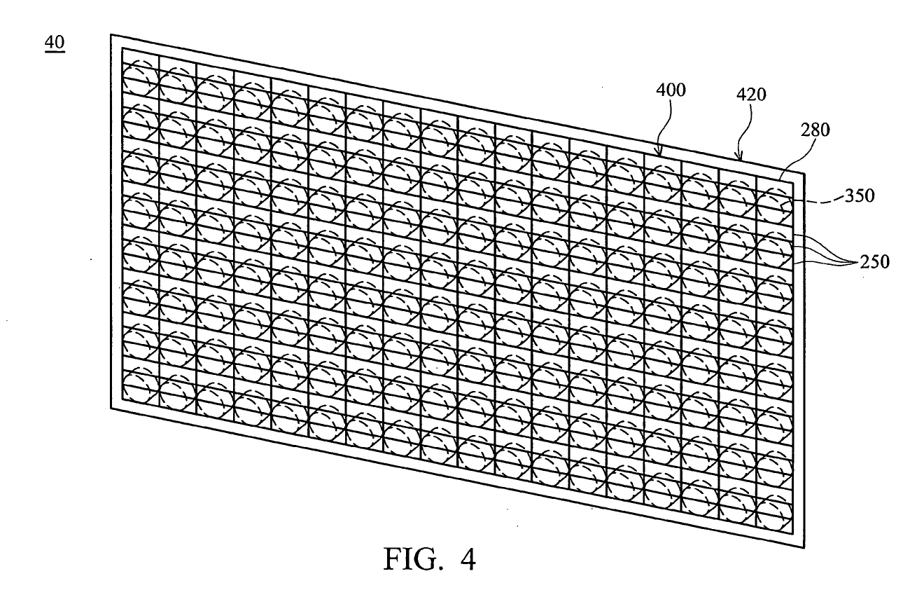

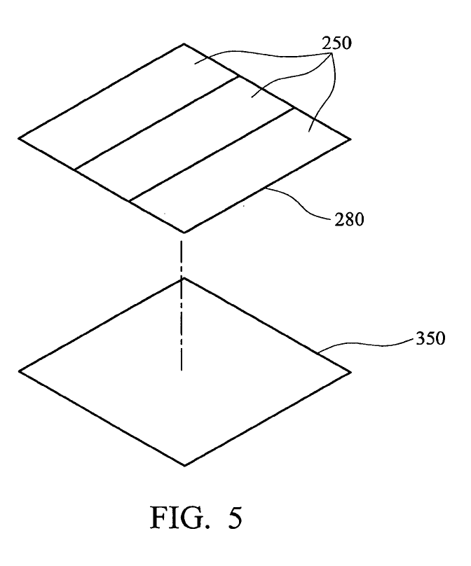

FIG. 4 schematically illustrates a display device 40 according to another embodiment of the invention. Display device 40 comprises a color LCD panel 400 and a backlight module 420, wherein color LCD panel 400 comprises a plurality of pixel units 280. According to the embodiment of the invention, backlight module 420 can be an OLED panel with a plurality of light emitting elements 350, wherein each light emitting element 350 may correspond to one pixel units 280. In this illustrated embodiment, each pixel unit 280 comprises three display cells 250, respectively a red display cell, a green display cell and a blue display cell. FIG. 5 schematically illustrates the one-to-one arrangement between of one pixel unit 280 and one light emitting element 350 shown in FIG. 4, wherein one pixel unit 280 comprises three display cells 250 and one light emitting element 350 is arranged to illuminate the corresponding pixel unit 280.

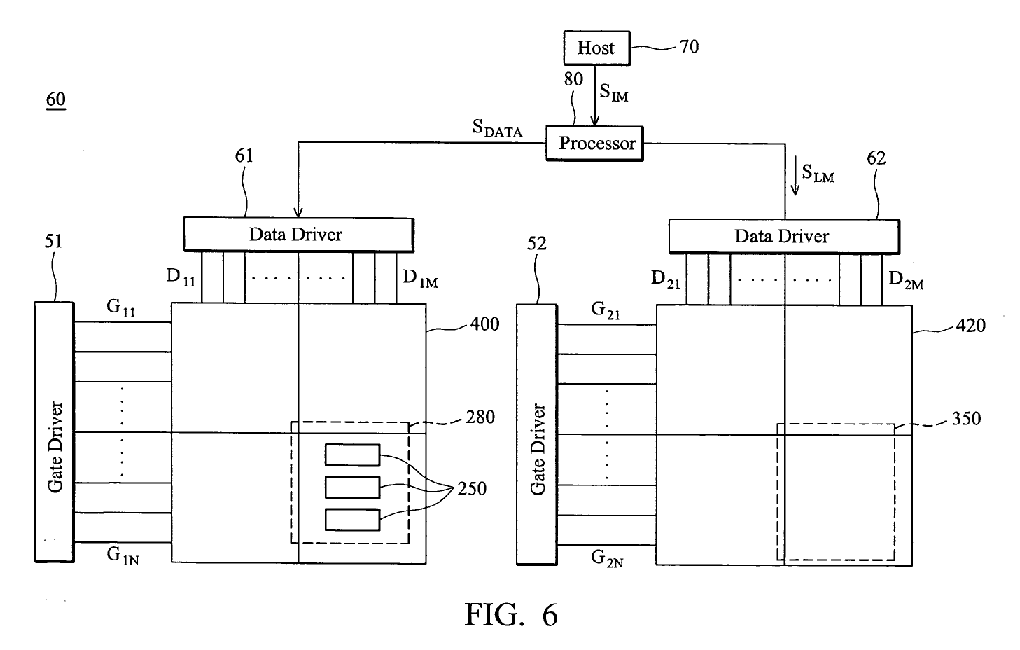

FIG. 6 schematically illustrates the circuit driver of a display device 60 according to the embodiment shown in FIG. 4. Each light emitting element 350 is arranged correspondingly to each pixel unit 280 and acts as an individual backlight source for each pixel unit 280. For example, each light emitting element 350 is arranged to be positioned behind each corresponding pixel unit 280 and is used to dynamically and individually illuminate the corresponding pixel unit 280 according to the luminance signal S_{LM}. The luminance signal S_{LM} is determined by the processor 80 based on the image attribute. In one embodiment, the luminance signal S_{LM} is determined according to a maximum of the brightness of the red channel signal, brightness of the green channel signal and brightness of the blue channel signal of each individual pixel in a color image data. In another embodiment, the luminance signal S_{LM} is determined according to a mean value among the brightness of the red channel signal, brightness of the green channel signal and brightness of the blue channel signal of each individual pixel in a color image data.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A display device, comprising:
a processor for receiving an image signal and generating a data signal and a luminance signal accordingly;
a display panel comprising a plurality of display cells;
a data driver generating a plurality of driving signals according to the data signal for driving the display cells; and
a backlight module comprising a plurality of light emitting elements, each light emitting element being arranged to correspond to each display cell respectively for emitting light to each display cell according to the luminance signal.

2. The display device as claimed in claim 1, wherein the processor generates the data signal by adjusting an attribute of the image signal, and generates the luminance signal based on the adjusted attribute.

3. The display device as claimed in claim 2, wherein the attribute is contrast ratio.

4. The display device as claimed in claim 2, wherein the attribute is brightness.

5. The display device as claimed in claim 1, wherein each light emitting element is positioned behind its corresponding display cell.

6. The display device as claimed in claim 1, wherein the light emitting elements emit white light.

7. The display device as claimed in claim 1, wherein each three display cells form a pixel unit, and wherein the three display cells are a red display cell, a green display cell, and a blue display cell, respectively.

8. The display device as claimed in claim 7, wherein each three light emitting elements correspond to the three display cells forming the pixel unit, and the three light emitting elements are a red light emitting element, a green light emitting element and a blue light emitting element, respectively.

9. The display device as claimed in claim 1, wherein the light emitting elements are organic light emitting diodes.

10. A display device, comprising:
a processor for receiving an image signal and generating a data signal and a luminance signal accordingly;
a display panel comprising a plurality of pixel units;
a data driver generating a plurality of driving signals according to the data signal for driving the pixel units; and
a backlight module comprising a plurality of light emitting elements, being arranged to correspond to the pixel units respectively for emitting light to the corresponding pixel unit according to the luminance signal.

11. The display device as claimed in claim 10, wherein the processor generates the data signal by adjusting an attribute of the image signal, and generates the luminance signal based on the adjusted attribute.

12. The display device as claimed in claim 11, wherein the attribute is contrast ratio.

13. The display device as claimed in claim 11, wherein the attribute is brightness.

14. The display device as claimed in claim 10, wherein each light emitting element is positioned behind the corresponding pixel unit.

15. The display device as claimed in claim 10, wherein each pixel unit comprises a red display cell, a green display cell and a blue display cell.

16. The display device as claimed in claim 10, wherein the image signals comprise information of brightness of a red channel signal, a green channel signal and a blue channel signal of each pixel unit, and the processor uses an algorithm to generate the luminance signal according to the image signal for controlling each light emitting element to individually emit the light and to illuminate the corresponding pixel unit.

17. The display device as claimed in claim 16, wherein the algorithm is to choose a maximum value as the luminance signal from the brightness of the red channel signal, the brightness of the green channel signal and the brightness of the blue channel signal of each pixel unit.

18. The display device as claimed in claim 16, wherein the algorithm is to calculate a mean value among the brightness of the red channel signal, the brightness of the green channel signal and the brightness of the blue channel signal of each pixel unit, and set the mean value as the luminance signal.

19. The display device as claimed in claim 10, wherein the light emitting elements emit white light.

20. The display device as claimed in claim 10, wherein the display cells are liquid crystal cells.

21. The display device as claimed in claim 10, wherein the light emitting elements are organic light emitting diodes.
